(19) United States
(12) Patent Application Publication
(10) Pub. No.: US 2013/0030860 A1
(43) Pub. Date: Jan. 31, 2013

(54) MANAGING INSPECTION, TEST, ANALYS, AND ACCEPTANCE CRITERIA (ITAAC) ACTIVITIES, SYSTEMS AND METHODS

(71) Applicants: Nikhil Chaubey, Greenville, SC (US); Deborah Johnson, Kinnewick, WA (US); Charumathi Vasudevan, Simpsonville, SC (US); Austin Higgs, Greenville, SC (US); Sheila Koza, Taylors, SC (US)

(72) Inventors: Nikhil Chaubey, Greenville, SC (US); Deborah Johnson, Kinnewick, WA (US); Charumathi Vasudevan, Simpsonville, SC (US); Austin Higgs, Greenville, SC (US); Sheila Koza, Taylors, SC (US)

(73) Assignee: FLUOR TECHNOLOGIES CORPORATION, Aliso Viejo, CA (US)

(21) Appl. No.: 13/505,124

(22) PCT Filed: Oct. 29, 2010
(86) PCT No.: PCT/US10/54652

§ 371 Date: Jul. 23, 2012

Related U.S. Application Data
(60) Provisional application No. 61/256,420, filed on Oct. 30, 2009.

(51) Int. Cl. G06Q 10/06

(52) U.S. Cl. 705/7.27

(57) ABSTRACT

An construction workflow tracking system is presented where the tracking system is capable of tracking component-level information associated with achieving closure for an Inspection, Tests, Analyses, and Acceptance Criteria (ITAAC) under 10 CFR Part 52 for licensing of new nuclear power reactors. Disclosed systems include an estimation engine configured to analyze workflow data points to estimate one or more compliance metrics, especially compliance dates (e.g., inspection dates, test dates, acceptance dates, etc.). A reporting engine can present estimated compliance dates with a confidence level or recommendations on improving confidence or reducing risk. Compliance dates can also include compromise dates indicating when a closed ITAAC is likely to be compromised.

This application claims the benefit of priority to U.S. provisional application having Ser. No. 61/256,420 filed on Oct. 30, 2009. This and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

### FIELD OF THE INVENTION

The field of the invention is plant manufacturing technologies.

### BACKGROUND

Building a nuclear power plant requires strict adherence to a number of Inspection, Tests, Analyses, and Acceptance Criteria (ITAAC). The process for working with ITAAC is new to the nuclear industry as required by 10 CFR Part 52 for the licensing of new nuclear power reactors. It is extremely important to meet the acceptance criteria and process closure documents correctly the first time. The importance of ITAAC cannot be stressed enough in construction project, because fuel loading will not be permitted until all ITAAC have been met and the Nuclear Regulatory Commission (NRC) has issued their finding per 10 CFR 52. 103(g).

To illustrate the complexity of the problem of achieving a fuel loading event, consider the ITAAC for an Advanced Boiling Water Reactor (ABWR). At the time of writing, there are approximately 939 ITAAC for each ABWR. Various ITAAC inspections, tests, or analysis are performed throughout the life of the project, typically lasting 4 to 5 years each. Tracking and maintaining such information is extremely difficult due to the sheer amount of data that must be collected and organized from across multiple third party organization or possible changes in a construction environment. For example, one or more components (e.g., welds, pipes, etc.) within a construction project could be considered to have passed an inspection and contribute to acceptance or closure of an ITAAC. However, during construction before fuel loading, the component could become damaged thus comprising acceptance of the ITAAC. Furthermore, due to the shear number of individuals, firms, or government entities involved in achieving acceptance of ITAAC, a desirable ITAAC management solution should be able to provide estimates on compliance dates (e.g., inspection dates, acceptance dates, delivery dates, etc.) taking into account the dynamic nature of the construction project down to an individual component level. Disseminating estimated compliance dates to partners allows for greater efficiency when coordinating efforts and also provides a leading indicating of potential problems.

Co-owned international patent application WO 2010/042524 to Chaubey et al. titled “Systems and Methods of Integrated and Automated Generation of Work Packages”, filed Oct. 6, 2009, provides some insight into developing a system for providing documentation to meet various ITAAC, but fails to address coordinating efforts among partners, especially when critical compliance dates are to be meet.

The construction industry in general continues to develop technologies in support for building plants or other types of facilities including nuclear facilities. UniStar® Nuclear Energy described their work in a presentation by Gibson titled “Moving Forward with the USEPR” given in 2009, and described their UniStar Galaxy™ offering in a video located at URL www.unistarnucelar.com/galaxy. UniStar provide additional information regarding their efforts and experiences with ITAAC in a paper by Sather et al. titled “Safeguarding investment to enable high performance in the nuclear industry” presented at the 34^{th} World Nuclear Association Annual Symposium 2009. Westinghouse Electric Company presented an AP1000 status in a talk by Ray titled “AP1000 ITAAC Update” given on Mar. 19, 2009. Such products and services aid in ensuring compliance with regulations, but still fail to fully address estimating one or more compliance dates.

Still, others have put forth effort toward complying with regulations. European patent EP 0 823 118 to Cooney et al. titled “Integrated Data Management System for Nuclear Power Plant Components”, filed Apr. 26, 1996, focuses mainly on tracking components within a power plant over its lifetime by compiling inspection data. In a similar vein, U.S. Pat. No. 7,149,701 to McKinney titled “Regulatory Compliance System and Method”, filed Nov. 2, 2001, also describes a compliance system where inspection schedules can be monitored to ensure compliance. Both of these references fail to appreciate that estimating a compliance date with respect to one or more acceptance criteria during construction can greatly increase efficiency of coordinating efforts among partners.

The following references also describe various aspects of ensuring that a construction project is in compliance with regulations:

U.S. Pat. No. 7,426,458 to Horton et al. titled “Nuclear Reactor Reload Licensing Analysis System and Method”, filed Dec. 30, 2004, describes a system for ensuring that a nuclear reactor is licensed for a fuel reloading.

U.S. Pat. No. 7,456,762 to Wetzer et al. titled “Optimization of Management of Maintenance, Repair, and Overhaul of Equipment in a Specified Time window”, filed Sep. 4, 2001, mainly focuses on marshalling resources for a task in a desired time window.

U.S. patent application publication 2002/0129001 to Levkoff et al. titled “Method and System for Assimilation, Integration and Deployment of Architectural, Engineering and Construction Information Technology”, filed Dec. 12, 2001, discloses a database solution for unifying nomenclature across information types in a construction project.

U.S. patent application publication 2010/0125528 to Reddy titled “System and Method to Supplement and/or Modify an ISO Quality System Program to Comply with Nuclear Power Plant Government Regulation Requirements and/or Standards Organization Requirements”, filed Nov. 16, 2009, describes a system capable of determining a gap between regulatory and standards organizations. When a gap is apparent, the system can create a revised quality assurance program.

FIG. 1 provides an overview of the complex closure requirements of the NRC as part of nuclear reactor licensing under the Part 52 process, clearly indicating an ITAAC management and tracking solution is required. What has yet to be appreciated is that a system for tracking and maintaining documentation or workflow data points at a fine level of granularity can contribute to ensure proper compliance with one or more ITAAC. Rather than merely providing reports, the system can use gathered data from a current construction project, or even historical projects, to generate estimated closure metrics associated with compliance. Closure metrics can include one or more types of compliance dates including inspection dates, closure dates, report dates, verification dates, or other compliance dates. Such a system allows for partners to have realistic expectations when important compliance dates are expected with some degree of certainty so they can properly cooperate with each other to achieve compliance in complex nuclear licensing ecosystem.

The requirements for ITAAC from the NRC are quite extensive. Thus, there is still a need for a workflow tracking system capable of tracking and maintaining a complex series of acceptance criteria to generating estimates on acceptance criteria compliance dates.

### SUMMARY OF THE INVENTION

The inventive subject matter provides apparatus, systems and methods in which one can utilize a workflow tracking system to generate estimated compliance date associated with project closure acceptance criteria, possibly including regulatory or standardized criteria (e.g., ITAAC, etc.), or other compliance requirements. A tracking system can include a workflow engine that has access to a workflow database storing project data. Example project data can include closure criteria objects representing instantiated versions of acceptance criteria for the project. In addition, the database can store workflow data points linked or otherwise associated with the criteria objects, and can also store compliance requirements for the criteria objects, the requirements reflecting the state of compliance for each criteria object.

Desirable workflow systems can also include a partner interface through which myriad partners (e.g., construction firms, clients, contractors, agencies, government entities, managers, etc.) can submit workflow data points. The workflow data points comprise data, which can include fine granularity component-level data about specific project characteristic (e.g., inspections, tests, analyses, component data, etc.). Furthermore the data points can include one or more attributes describing aspects of the data itself (i.e., metadata) or aspects of data point (e.g., properties, characteristics, etc.). In some embodiments, attributes across the data points, or criteria objects, are normalized according to a common schema to allow for easy comparison, identification, evaluation, or other forms of analysis.

The workflow system can also include an estimation engine configured to analyze data from the workflow data points, criteria objects, compliance requirements, or other available data and to generate one or more estimates for compliance dates. The estimated dates can be compiled into a report and provided to partners via a reporting engine, possibly embodied by the partner interface.

In some embodiments, estimated compliance dates can include one or more confidence levels reflecting, at least to some degree, the certainty of the estimated dates. Confidence levels, including error estimates on the dates, can be generated by comparing a current project's dates to historical project dates, by tracking dynamic changes to a project's workflow data points, or even by running Monte Carlo simulations.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 presents an overview of the prior art 10 CFR Part 52 closure process for an ITAAC.

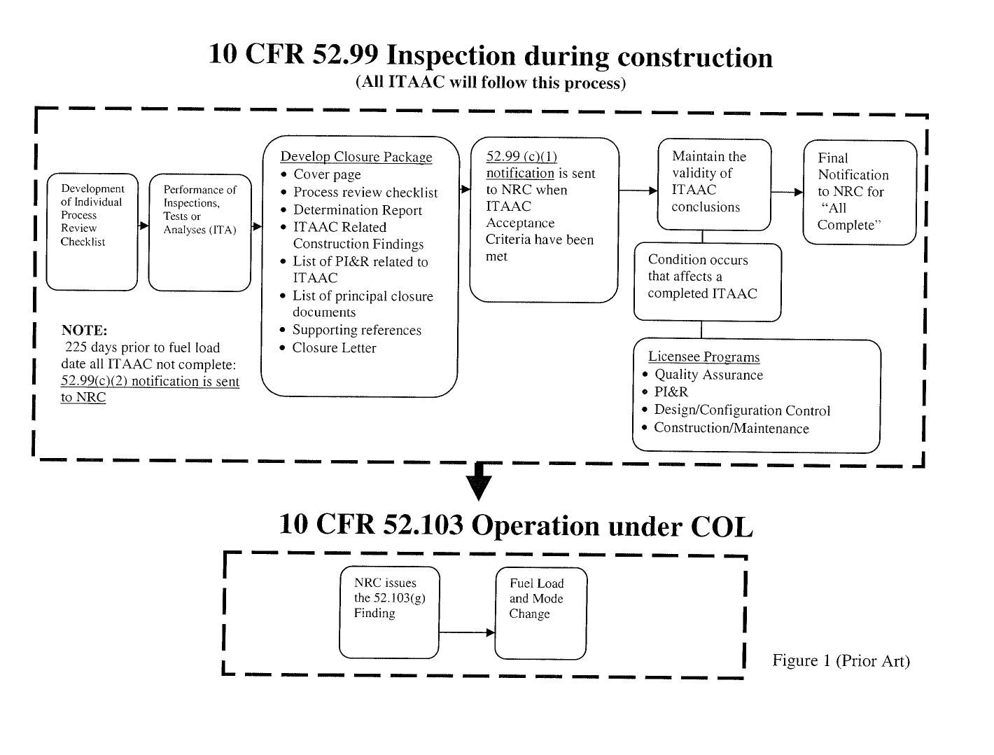

FIG. 2 provides a schematic of a possible information management system configured to store component-level information relating to ITAAC.

FIG. 3 provides a schematic overview of a workflow engine capable of generating estimated compliance dates based on fine grained workflow data points.

FIG. 4 provides a schematic overview of how ITAAC objects can be associated with workflow data points via attributes.

FIG. 5 graphically illustrates estimated compliance dates with confidence levels as a function of time and an attribute value.

FIG. 6 graphically illustrates risk of an accepted ITAAC becoming compromised after closure.

### DETAILED DESCRIPTION

It should be noted that while the following description is drawn to a computer/server based workflow system and estimation engine, various alternative configurations are also deemed suitable and may employ various computing devices including servers, interfaces, systems, databases, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclose apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including increasing efficiency of large scale construction projects through disseminating estimated compliance dates across independent third parties.

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

### Overview

The disclosed subject matter is presented within the context of building nuclear reactors according to standardized acceptance criteria (e.g., ITAAC). One should note the disclosed techniques can be applied to other types of constructions beyond reactors. For example, the disclosed techniques could also be applied to building of hospitals, power plants, large vessels (e.g., aircraft carriers), or other constructions where multiple partners work together as a team to build a structure that must adhere to strict auditing, compliance, or other closure requirements.

Processes for closing ITAAC are very loosely described in corresponding regulatory documents. Unfortunately, the complexity of closure requirements coupled with the massive amounts of data required to support closure places achieving closure on ITAAC well beyond the capability of a human being. Therefore, one aspect of the inventive subject matter includes a tracking system that monitors ITAAC processes and provides a detailed audit trails for each ITAAC at a fine level of granularity. For example, workflow data points can be associated with each ITAAC at the system level, component level, inspection level, test level, or other level of detail as desired.

Handling ITAAC processes has been was identified as one of the largest risk factors for building new nuclear reactors the Part 52 process. The disclosed system incorporates risk mitigation strategies throughout the process. For example, each of the current 939 ITAAC can be tracked for many years during design, procurement, or construction while the acceptance criteria are being met. Given the dynamic natures of each phase and workflow data points, various ITAAC can be compromised due to shifting data.

A report can be provided to a verification agency to support the verification or the validation of acceptance criteria. For example, a closure report can be provided to the NRC, which will review the final closure package for acceptance. It is important that the NRC be able to perform their reviews as the closure process progresses. It is also contemplated that a workflow engine can provide estimates of inspection dates or other compliance dates to the NRC based on the stored workflow data points. The construction projects that include constructing new nuclear reactors may involve many different companies, partners, agencies, or even individuals. ITAAC affect all companies assigned to the Engineering, Procurement, and Construction (EPC) team and it is considered useful to have a closure process that the entire EPC team follows to maintain consistency or coherency. Handling of such complex processes is well beyond the capability of manual processing, which would result in an unacceptably high error rate. Deployment of the disclosed systems and processes is expected to mitigate the risk of potential errors that could be caused by a manual processing of an extensive data collection maintained over years.

The disclosed computer-based system enables the ITAAC organization to effectively and efficiently track ITAAC activities and maintain consistency or coherency throughout the ITAAC closure process, especially across partners. In some embodiments, the system takes the form of a web application that allows all the EPC team members to track ITAAC closure in real-time. It also provides a function of sorting through many acceptance criteria (e.g., the 939 ITAAC for an AWBR reactor) based on many different fields: ITAAC number, division of responsibility, description, NRC family, work breakdown structure, classification, building, location, or many other possible fields.

The system can also comprise one or more risk mitigation tools. Examples include Individual ITAAC Closure Requirements Checklist (ICRCs) and ITAAC Compliance Verification (ICV). The ICRCs are virtual road maps that entities across an entire project can use to identify required activities and documents considered necessary for closure of one or more ITAAC. The NRC, or other agency, can review the ICRCs to make sure that the project's path forward will meet closure requirements in a timely fashion. An ICV process can be performed on documents related to closure to ensure that the ITAAC requirements are included early in the project. Such an approach aids in generating or refining estimated compliance dates by increasing certainty of an estimated date. In addition project risk is reduced by identifying deficiencies prior to critical phases of the project. An ICV form available via a partner interface can be linked to a master document list as well as the ICRCs. A portion of the data required for various forms can be auto-populated from workflow database, which reduces the opportunity for human error. The web-based system can be streamlined the approval process through electronic signatures. One should appreciate that the risk mitigation tools (e.g., ICRCs, ICV, etc.) can be provided as interfaces, through which project partners or team members can access the tools, assuming suitable authentication or authorization requirements are met. Project team members will also be able to access real-time information, improving efficiency as well as providing a systematic approach to the closure process.

ITAAC schedule information can also be available via the web application. The system can provide real-time access, update capability to users in multiple organizations, interface with electronic document management system, or all required security features (e.g., access/content control based on user's role, digital signatures, authentication, authorization, confidentiality, data integrity, etc.). ITAAC schedules are considered to include estimated real-time, updated compliance dates associated with achieving closure. Estimated compliance dates are more than mere milestones of a project. Rather, estimated compliance dates are calculated by folding in many factors gathered from workflow data points that can affect dates. The security features within the ITAAC system allow restriction of access in various ways, i.e., restriction of individual information fields to users, groups restricted to specific ITAAC families, and “Read-Only” access to certain users. In addition, the ITAAC system can contain audit features to track changes to data, for example, what was changed, by whom, or the date the change was made. Tracking such changes further allows for dealing with dynamic changes in the system.

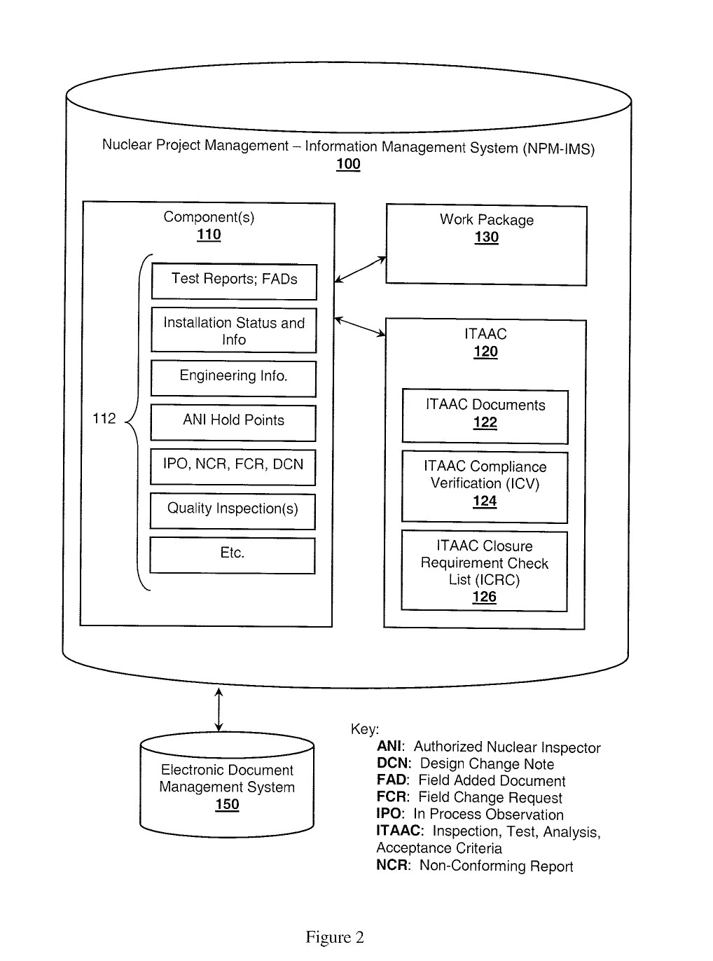

FIG. 2 is a diagram of a possible nuclear project management and information management system (NPM-IMS) 100 configured to store workflow data during a construction project. NPM-IMS100 enables an ITAAC organization to attach/track ITAAC-related record information such as vendor inspection documents, weld inspections, specifications, test reports and other critical workflow data points (e.g., status, documentation, etc.) required to prove the acceptance criteria for ITAAC has been met sufficiently. The data can be stored at a project-level, site-level, partner-level, down to a component-level.

One or more components 110 can be stored in the system within a workflow database where components 110 represent data about traditional construction project components (e.g., materials, assemblies, construction modules, valves, equipment, welds, pipes, etc.). Components 110 can also include non-traditional components: people, documentation, partners, training sessions, or other items that could impact achieving closure, possibly through indirection relationships. Components 110 can be considered an item relating to a construction project. Individual ones of components 110 also can be an aggregate of others components 110 as well, possibly linked together via relationships determined by a project plan.

During various phases of a project (e.g., design, construction, operation, end-of-life, etc.) component data 112 is collected. Example component data 112 includes test reports, field added documents, installation status and information, engineering information, authorized nuclear inspector information, hold points, in-process observations, non-conforming reports, field change requests, design change notes, quality inspections, or other information. One should easily appreciate there is the wealth of dynamic information available about each component through an entire life cycle of a project. Component data 112 is considered to be fully dynamic and could change on a daily, hourly, minute, or even real-time basis. Furthermore, one should appreciate the component data can be historical information gathered from previous construction projects where the historical data can be leveraged to estimate closure metrics, including compliance dates. All the information available in the NPM-IMS can be made available via a reporting engine or through Electronic Document Management System (EDMS) 150.

Components 110 preferably have a data relationship with work packages 130 and ITAAC 120. Work packages are more fully described in co-owned international patent application WO 2010/042524 to Chaubey et al. titled “Systems and Methods of Integrated and Automated Generation of Work Packages”, filed Oct. 6, 2009. Work packages 130 can depend on one or more components 110, which in turn can be linked to one or more ITAACs. Should one or more of work packages 120 require interaction with a component 110 associated with a closed ITAAC 120, the closed ITAAC 120 might be at risk of becoming compromised. To mitigate risks of compromising ITAAC 120, each ITAAC 120 can also include documentation 122, ICV data 124, or ICRC 126 that can aid workers by instructing them of possible risk.

As construction on a new reactor progresses, it is considered useful to have an ITAAC organization know when an individual component 110 might be damaged or is having maintenance performed to determine if a corresponding ITAAC is at risk of becoming compromised. The component data 112 can be collected during construction, installation, or quality control process. Components 110 can be cross-referenced via a component ID or other component attributes found in one or more of ITAAC 120. Thus, an ITAAC 120 can be “flagged” should an issue concerning an associated component 110 arise. To be clear, as work is performed for a project workflow data is collected and analyzed to determine if there are possible impacts on ITAAC 120, including any effected dates.

### Workflow Engine

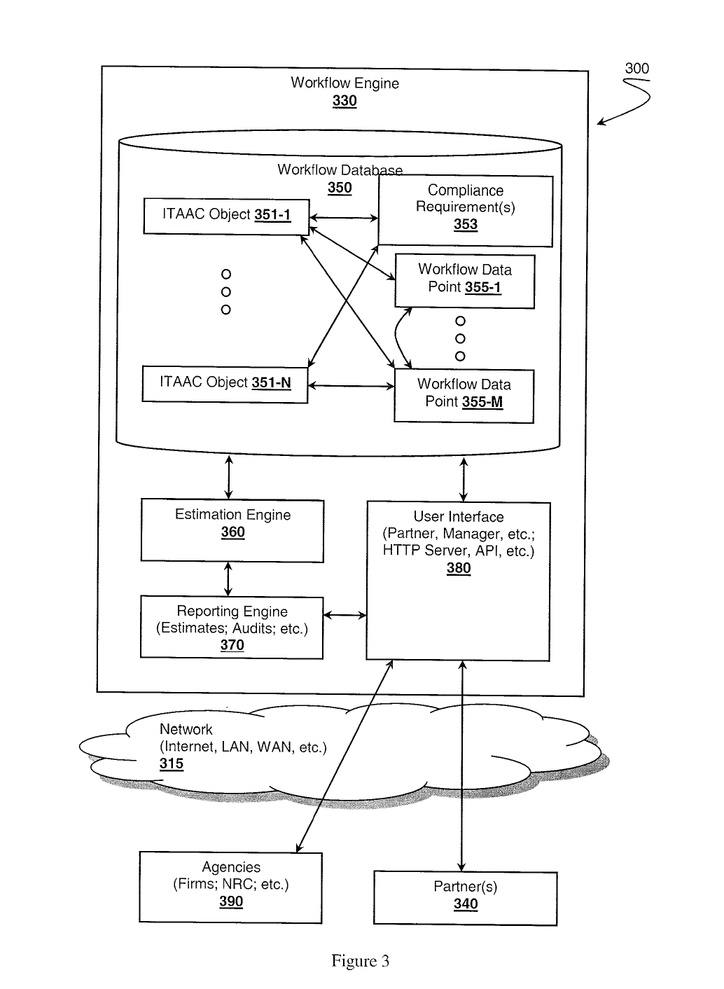

FIG. 3 presents an ITAAC construction workflow tracking system 300 including workflow engine 330 that has access to workflow database 350. In the example shown, workflow engine 330 is illustrated as having various internal elements. However, it is contemplated that other configurations or arrangements of the elements can achieve the desired results. For example, estimation engine 360 or reporting engine 370 could be separate computing devices communicatively coupled with workflow engine 330 over network 315.

Workflow database 350 can be configured to store various types of data objects to facilitate bringing one or more ITAAC to closure. For example workflow database can store one or more of ITAAC objects 351-1 through 351-N, collectively referred to as ITAAC objects 351, representing individual objects that correspond to a construction project's acceptance criteria, preferably a standardized acceptance criteria (i.e., ITAAC, AWBR ITAAC, etc.). Consider an example associated with construction of an AWBR. A project would likely have 939 instantiated ITAAC objects 351 that can be instantiated from the AWBR ITAAC and that can be used to track closure of the project.

ITAAC objects 351 can be stored in any suitable format or schema. In some embodiments, ITAAC objects 351 comprise one or more attributes describing aspects of a specific ITAAC with respect to a specific project where the attributes have been normalized according to a common attribute schema. Such an approach allows for comparing ITAAC objects 351 from one project to another, or correlating ITAAC objects 351 to workflow data points 355 or correlating other objects in workflow database 350. In addition to attributes, ITAAC objects 351 can also include closure requirements 353, links to other data objects, identifiers, component information, metadata or other types of information. In view that ITAAC objects 351 can be a project-level instantiated embodiment of an ITAAC, one should appreciate that workflow database 350 can also store historical ITAAC objects 351 possibly associated with previously completed projects. Historical ITAAC objects 351 can be quite valuable when estimating one or more closure metrics, especially compliance dates.

Closure requirements 353 can be associated with one or more of ITAAC objects 351 where closure requirements 353 indicate closure acceptance criteria that ITAAC objects 351 should satisfy to achieve compliance with an ITAAC. Although closure requirements 353 are illustrated as being stored as separate objects from ITAAC objects 351, closure requirements 353 can be stored as part of ITAAC objects 351. Closure requirements 353 can be stored as one or more closure objects incorporating closure requirements across multiple objects. ITAAC objects 351 can link to closure requirements 353 collectively or individually as desired. In other embodiments, ITAAC objects 351 can include data representing specific closure requirements for its corresponding ITAAC.

Workflow data points 355-1 through 355-M, collectively referred to a workflow data points 355, where workflow data points 355 represent data describing aspects of a construction project, possibly collected as a result of issuance of one or more work packages. For example, a worker might be assigned an ICRC or ICV form to complete. Workflow data points 355 can include component-level information for just about anything associated with a construction project. Example workflow data points 355 can include inspection results, weld inspections, test results, analysis information, specifications, training material, worker information, schedules, or other data relating to a project. One should keep in mind that workflow data points 355 can include data from across a wide spectrum of sources including human resources, accounting, operations, legal, partners, clients, government agencies, or other sources of information both internal or external to the entity managing closure of the ITAAC.

One should consider workflow data points 355 as living data reflecting at least a current project. In addition, workflow data points 355 can also be considered dynamic data capable of changing in real-time as partners 340 provide updates to workflow data points 355. As with ITAAC objects 351, workflow database 350 can also store historical workflow data points 355 from previous projects.

Workflow data points 355, as previously stated, can comprise component-level information that can also be stored based on attributes describing the workflow data points 355. In some embodiments, attributes for workflow data points 355 are stored according to a common normalized attribute schema utilized for ITAAC objects 351. Such an approach allows for quickly identifying which workflow data points 355 can be linked, or should be linked, to ITAAC objects 351 or to other workflow data points 355. For example, workflow data point 355-1 links to workflow data point 355-M, but does not necessary link to ITAAC object 351-N.

The various objects stored within workflow database 350 provides a foundation of information from which estimation engine 360 can calculate various metrics, including compliance date, associated with closure of ITAAC for a project. Workflow database 350 can archive workflow data points 355, or other objects, for extended periods of time throughout the lifetime of a construction project; from conception through end-of-life. For ITAAC compliance, workflow database 350 can be configured to archive data objects for four, five, ten, or more years. Archiving or logging historical data objects provides for generating audit trails or for comparing efforts from one project to another.

Estimation engine 360 can access workflow database 350 to request information associated with ITAAC objects 351 or workflow data points 355. For example, when conducting an analysis of ITAAC object 351-1 to determine status of closure, estimation engine 360 can follow links associated with ITAAC object 351-1 to gain access to closure requirements 353 or workflow data point 355-1, which might in turn provide access to workflow data point 355-M. Thus, estimation engine 360 can determine how a seemingly unrelated workflow data point 355-M could affect an analysis of ITAAC 351-1.

Reporting engine 370 can communicatively couple with estimation engine 360 and can generate an analysis report for various users of system 300 where an analysis report can include final closure documents, interim documents, ICRC, ICV documents, estimate reports, or other documentation as desired. Reporting engine 370 can be used to configure user interface 380 to present desired reports, possibly via a web interface. Reporting engine 370 can compile and present a closure report indicating estimated metrics provided from estimation engine 360, including estimated compliance dates. Naturally, users of system 300 (e.g., partners 340, agencies 390, etc.) can access reporting engine 370 via user interface 380 to instruct reporting engine 370 how to compile a closure report.

Keeping in mind that workflow data points 355 can dynamically change in real-time as partners 340 provide workflow data, reports that depend on such data can also change in real-time. Reporting engine 370 can be configured to provide a real-time audit trail for ITAAC objects 351 as data changes. For example, one of partners 340 can access workflow engine 330 via partner interface (e.g., user interface 380) to view one or more reports associated with ITAAC objects 351. As additional new data flows through the system, reporting engine 370 can configured user interface 380 to provide updated versions of the report (e.g., graphs, charts, spreadsheets, estimated dates, errors in date calculations, confidence levels, etc.). The audit trail can also include reports based on historical or previously logged workflow data.

User interface 380 is illustrated as an HTTP server allowing remote users to access system 300 over network 315. In other embodiments, user interface 380 could include a GUI, an API, or other type of interface. For example, user interface 380 could include a GUI on a partner's computer that access system 300 via a web services API.

Partners 340 participating in a construction project can use user interface 380, operating as a partner interface, to submit workflow data points to workflow engine 330. As partners 340 work on the projects, they collect data associated with various work packages. The data can then be uploaded, possibly automatically, to workflow database 350. One should note that one or more of partners 340 might utilize a proprietary format or nomenclature for workflow data points 355. Therefore, workflow engine 330 can include a data conversion module (not shown) that translates from the partner's format into a normalized schema.

### Estimation Engine

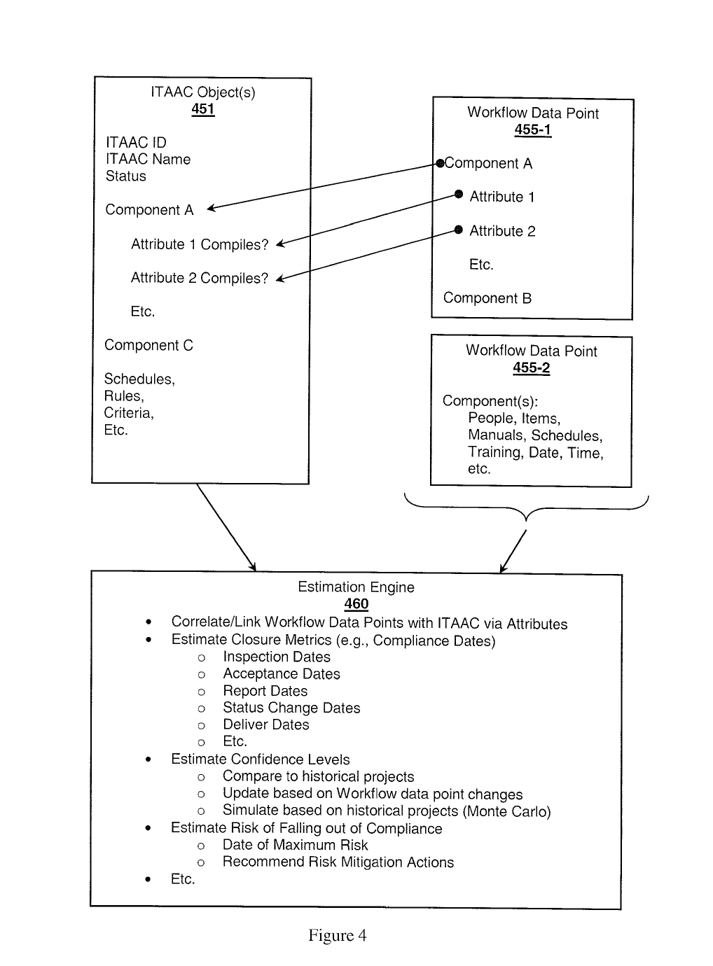

FIG. 4 provides a more detailed overview of how an estimation engine 460 interacts with one or more of ITAAC object 451 and workflow data points 455-1 or 455-2, collectively referred to as workflow data points 455. In the example shown, ITAAC object 451 and workflow data points 455 comprises component-level information detailed by attributes. Estimation engine 460 can be configured to generating estimated closure metrics, including estimated compliance dates of ITAAC objects 451 as a function of the workflow data points 455 and compliance requirements. For example, estimation engine 460 can leverage attribute information to establishing relationships among the various data objects and to use the attribute data to calculate estimated compliance dates, errors associated with estimated dates, or confidence levels of an estimated compliance date.

Attributes can be single valued or multi-valued data object. For example, an attribute could include a simple time stamp having a single time when a data point was collected. A more likely attribute would be a multi value vector of information including an identifier, a normalized name, normalized values, initial name, actual values, links to other objects, value ranges, or other information.

In some embodiments, as discussed previously, attributes can be stored according to a normalized attribute schema where the schema provides for quickly correlating ITAAC object 451 with workflow data points 455, possibly through matching workflow attributes with attributes in ITAAC object 451. One possible schema includes a hierarchically arranged tree of attributes that can be used to describe aspects of a project by indicating relationships among attributes. Attributes can be arranged by different phases of a project (e.g., design, procurement, construction, operation, end-of-life, etc.), different levels of a project (e.g., client, project, phase, work package, worker, etc.), or other arrangements. Another possible schema includes arranging attributions in a multiply linked namespace were attributes have pre-established correlations already indicated by names in the namespace. Regardless of how one chooses to form an attribute schema, one should appreciate that a desirable schema would provide a unified view among stored objects or across projects.

Example attributes for ITAAC object 451 can include an ITAAC identifier, an ITAAC name, project identifier, current status of ITAAC, component information, values for various attributes, time stamps, scheduling information, rules for evaluating an ITAAC, closure requirement criteria, or any other information desirable for tracking closure of an ITAAC. For example, ITAAC object 451 references two components, components A and B. The component information within the ITAAC object can include closure conditions required for each relevant component's attributes. Closure would be achieved when all conditions are met. In the example shown, a correlation exists between ITAAC object 451 and workflow data point 455-1 based component A. Therefore, estimation engine 460 can determine if the ITAAC associated with ITAAC object 451 can be closed by checking data within workflow data point 455-1.

One should appreciate that estimation engine 460 has access to a wealth of information across nearly all aspects of a construction project from conception, design, and even through end-of-life, all available through workflow data points 455. Estimation engine 460 can use the information, even at a very fine level of granularity, to calculate estimates on metrics for achieving closure on ITAAC object 451. Closure metrics can include document check in rates, frequency of changes to workflow data points, or other ITAAC related activities. An especially preferred closure metric includes estimated compliance dates.

To estimate one or more of a project's closure metrics relating to ITAAC, estimation engine 460 can establish relationships among ITAAC objects 451 and workflow data points 455. In some embodiments, a relationship link (e.g., a pointer) can be included the various objects so that estimation engine 460 can walk the links to determine which objects are correlated. However, it other more sophisticated embodiments, ITAAC objects 451 and workflow data points 455 can include one or more attributes, possibly at the component level. Estimation engine 460 can also establish correlations among ITAAC objects 451 and workflow data points 455 through analysis of a normalized attribute schema.

In some embodiments, estimation engine 460 can analyze historical data objects from one or more previously projects to determine if there is a correlation among historical ITAAC objects 451 and historical workflow data points 455 where a workflow data point 455 might not be directly link to ITAAC object 451. For example, estimation engine 460 could analyze historical data via one or more algorithms to determine that workflow data points 455-2 appears to have previously affected component C of ITAAC object. Once the correlation is established, it is considered likely that a similar correlation would exist for a current similar project, at least to within a confidence-level of the algorithms used in the analysis. Example algorithms that can be used to determine correlations include multivariate analysis, regression analysis, factor analysis, or other techniques.

Once estimation engine 460 determines that ITAAC object 451 can be influenced by or is correlated with workflow data points 455-2, estimation engine 460 can attempt to derive an estimated metric from the data. Closure metrics can represent one or more measures relating to achieving closure for one or more of ITAAC object 451 or all ITAAC for a project. Typical metrics can include rate of closure documents submissions, closure velocity, error rates, or other types of metrics. Such metrics, although useful, fail to provide a solid indication on when compliance dates will likely be achieved. The reason is the act or work associated with providing one or more closure documents does not necessarily impact how or when an additional document will be provided to achieve closure. Nor do such metrics take into account how an accepted ITAAC can become compromised. A better metric is considered to include estimated compliance dates.

The reader should not confuse estimated compliance dates with project milestone dates. It is true milestone dates represent a goal to be achieved, but does not properly take into account realities associated with a project. An estimated compliance date represents a calculated measure when a compliance date is likely to be actually achieved based on workflow data points 455, which can change dynamically or even dramatically as time goes by. Example compliance dates include inspection dates, status change dates, dates of maximum risk to an ITAAC, delivery dates, report dates, acceptance dates, test dates, analysis dates, or other dates associated with achieving closure of or compliance with an ITAAC.

A “zeroth” order estimate for a compliance date can be derived from a project plan by possibly adding work package task durations together. However, such an order of magnitude estimate is very likely unrealistic when working with many different partners, especially on a project having a lifetime measured in years and in a volatile global environment. Preferably, a compliance date estimate can be refined further by taking into account the wealth of information available via workflow data points 455.

A refinement of the estimated compliance date can be determined via one or more computer based calculations based on the available data. In some embodiments the estimated compliance dates are generated as a function of the statistical impact of attributes to an ITAAC compliance date. For example, workflow data might indicate that a welder is quite good and only has to redo work in less than 1% of cases, which might indicate that an inspection date would likely remain intact. Therefore, very little refinement of an estimated welding acceptance date would be required. However, a welder that is less experienced might require supervision in 80% of the work package tasks, which could cause several days of slip causing a significantly later estimated acceptance date. Such an approach is useful when statistics are available, especially based on historical data.

In other embodiments, possibly where fewer statistics are available, other techniques can be used can be to estimate compliance dates. Yet another technique that can be used for estimating a compliance date includes incorporating a measure of how often workflow data points 455 change. The frequency of change to workflow data points 455 can be indicative of a measure of instability in the data, which can in turn indicate instability of a compliance date associated with ITAAC object 451. Therefore, an estimated compliance date can depend on a frequency of change of portions of workflow data points 455. Still, historical data can be brought to bear against the calculation to determine a degree of effect of the frequency of change. Naturally, the degree of effect can also depend on which portions (e.g., attributes, components, metadata, etc.) of workflow data points 455 change. For example, if a weld inspection result for component A changes frequently, then an estimated compliance inspection date associated with ITAAC object 451 will likely change dramatically. However, if merely a time stamp changes indicating last update with no effect on core data, then an estimated compliance date would likely remain unchanged.

The reader should keep in mind that each type of closure metrics comprises different foundational elements contributing to a metric estimate. With respect to compliance dates, each type of compliance date can depended on different factors. For example, inspection dates require assigned workers, assigned inspectors, documentation, completed work package tasks, or other data directly relating to completion of a component for which the inspection is required. While an acceptance date indicating closure of an ITAAC depends more heavily on closure documentation (e.g., reports, ICRC documents, ICV forms, etc.), or previously met dates (e.g., inspection dates, delivery dates, report dates, etc.). In view of the different dependencies, each type of compliance date might require different functional requirements to estimate the compliance date. The function for deriving an inspection date would be different than the function for deriving an acceptance date, while both functions can incorporate similar techniques folding in statistical historical data, frequency of change, or other parameters.

Compliance dates represent dates associated with achieving closure or compliance of an ITAAC and can have many different types. Example compliance dates include the following:
a. Delivery dates: Dates associated with delivery of resources associated with a component related to an ITAAC.
b. Task dates: Dates associated with completion of a component task related to an ITAAC.
c. Inspection dates: Dates reflecting when an inspection of a component is likely to occur.
d. Test dates: Dates reflecting when an ITAAC test is expected to be complete.
e. Report dates: Dates by which an ITAAC report is expected to be available.
f. Acceptance dates: Dates when an ITAAC is expected to be closed.
g. Status change dates: Dates when an ITAAC status is expected to change from one state to another.
h. Compromise date: Date when an ITAAC is considered to be under risk of compromised.

A compromise date is of particular note. As discussed above workflow data points 455 are considered living, breathing data objects that can fluctuate in a dynamic fashion, even in real time as partners update associated data. It should be appreciated that workflow data points 455 can change even after ITAAC object 451 achieves acceptance, thus the corresponding ITAAC can become compromised as workflow data points 455 change. The disclosed techniques also include monitoring changes to workflow data points 455 and calculating a date when an ITAAC is likely to be comprised. A compromise date can include a date with a probability of compromise, or could include a most likely compromise date indicating a date when the probability is at a maximum value. Naturally, the most likely compromise date could change as time goes by in view of changes to data within workflow data points 455, and should be considered a moving date.

Status change dates or compromise dates are quite advantageous to have. Providing reports including status change dates or compromise dates to partners, agencies, or governments allows such entities to prepare for potential risks associated with an ITAAC. For example, an accepted or closed ITAAC under risk can be monitored more closely or can have a new inspection scheduled during risky events to ensure risk is reduced, which will be discussed below. The system can generate an ICRC or require individuals to complete ICV document to mitigate such risks.

### Confidence Levels

Estimated compliance dates, or other estimated compliance metrics for that matter, are estimated as a function of changing workflow data point attributes, historical data, or other types of data. In view that the compliance dates are estimates, one should appreciate the estimates can also include a confidence level for the estimate representing a calculated measure of how accurate the estimate is considered to be. An astute reader will recognize the correlation of a confidence level with an estimated error associated with an estimated date. Yet another aspect of the inventive subject matter is considered to include generating confidence levels, including error estimates, of an estimated date. A confidence level can include a spread or range around an estimated date. For example, an acceptance date might have a value of Dec. 21, 2012, with a range of ±five days at a 95% confidence level indicating there is a high degree of certainty that acceptance will be achieved between Dec. 16, 2012, and Dec. 26, 2012. The previous example is presented based on an assumption that the probability of achieving an estimated date and associated errors follows a Gaussian or normal distribution. Naturally, other distributions are also possible.

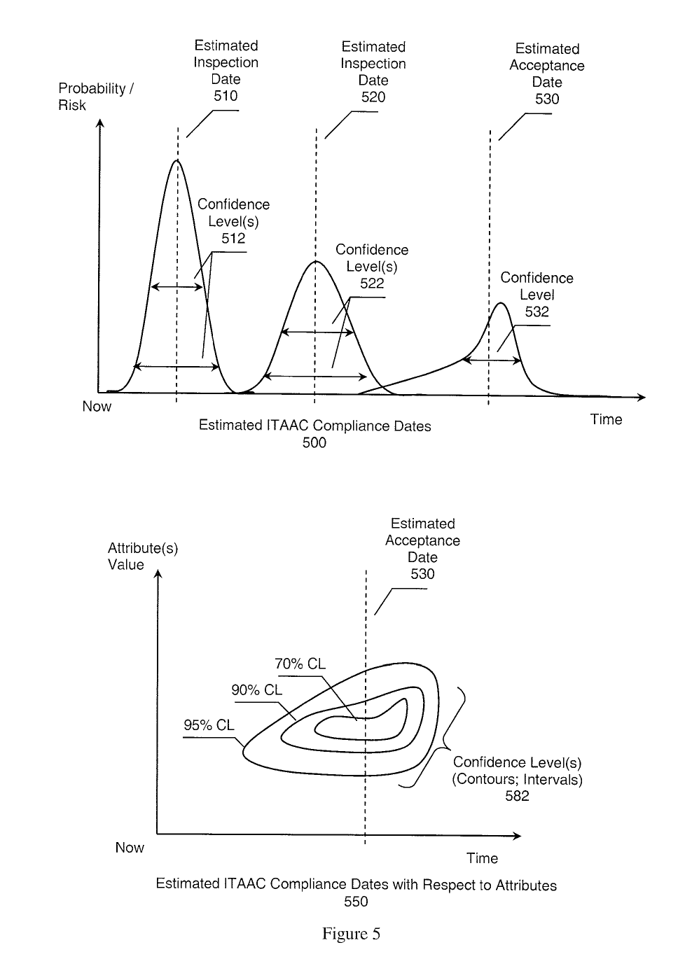

FIG. 5 presents two graphic illustrations representing confidence levels, and errors, associated with dates. Graph 500 presents a probability (or risk) of an estimated date versus time for three compliance dates: inspection date 510, inspection date 520, and acceptance date 530. The presented distributions are simple for clarity of presentation while actual distributions are more complex. Inspection date 510 is closer in time to “now” and is expected to have a high probability of being achieved relative to that of inspection date 520, which is further out in time and likely has many more fluctuating factors affecting its calculation. The widths of the distributions loosely represent a statistical or calculated error assorted with the dates. The confidence levels 512 and 522 can be derived from the estimated errors. For example, a normal distribution (as shown) having a width or error of a has a 68% confidence level. An approximately 95% confidence level would required a spread of 2σ, and so on, as based on known error function calculation.

As mentioned above an actual distribution associated with an estimated compliance date is unlikely to fall into an easily identifiable curve as illustrated by inspection dates 510 or 520. Estimated acceptance date 530 illustrates a distribution that is less regular, more or less a Poisson distribution, where the estimated acceptance date 530 might have different values depending on where in the distribution the date is selected to reside. As shown, acceptance date 530 is considered to be an average from the distribution with a confidence level 532. However, the most probable date is more distant in time.

One should also appreciate that a confidence level, and estimated date, can depend on workflow data point attribute values as illustrated in Graph 550 where estimated acceptance date 530 from Graph 500 is presented with respect to an attributes value. In graph 550 confidence levels 582 are presented as contour or confidence intervals. One should keep in mind that a confidence interval can more than one or two dimensional object as illustrated in Graphs 500 and 550. An estimated compliance date can depended on many different attributes and their values. Therefore, confidence levels can be represented in a multiple dimensional space for various attributes, thus allowing for optimization of an estimate by seeking attributes having better attributes as discussed below.

Probability associated with closure metrics, including estimated compliance dates, can be determined through various techniques. On technique includes incorporating statistical information from historical data to derive an error around a date, possibly based on a root mean square (RMS) of a sum of statistical errors from workflow data point attribute values or other similar technique.

Another interesting technique for generating a distribution around an estimated date includes running one or more Monte Carlo simulations based on historical data representing previous projects. Running multiple simulations where each simulation leverages different aspects of previous projects allow for building statistics for an estimated date. For example, when estimating a date for an inspection of a weld, a single simulation can incorporate assumed values for workflow data points from previous projects where a specified welder, and their associated data, is assigned to weld a component. Another simulation can then be run by specifying a different welder, and incorporating their associated data. The process is repeated until sufficient statistics are developed to establish a distribution for estimated dates and to determine errors or confidence levels.

Closure reports comprising estimated compliance dates or metrics having confidence levels are useful for more than merely presenting interesting statistics about achieving closure on an ITAAC. Confidence levels provide an indication of certainty of a date. When a high confidence level is accompanied by a larger error or range, partners are alerted to a situation likely primed for optimization. Should an estimated date have error over a threshold, possibly based on rules within an ITAAC object (see FIG. 4), the simulation engine can make recommendations for reducing risk.

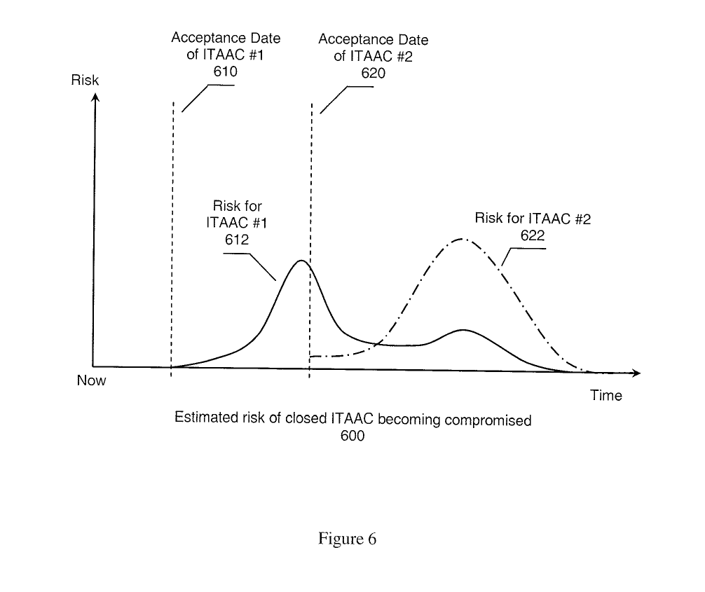

FIG. 6 illustrates a graph 600 representing risk of an accepted ITAAC becoming compromised. In the example, ITAAC #1 and ITAAC #2 have been accepted and are considered to be in compliance with their corresponding compliance requirements. ITAAC #1 and #2 have respective acceptance dates 610 and 620. However, work on the construction project continues, which could cause a change in state of one or more of the ITAAC. ITAAC #1 has a corresponding risk curve 612 indicating an estimated risk of ITAAC #1 becoming compromised as a function of time and based on workflow data points. For example, although ITAAC #1 is closed, work might continue on gaining acceptance for ITAAC #2 where the work might include work packages directing an individual to work closely with or near components related to ITAAC #1. Should the work interfere with the ITAAC #1's components, ITAAC #1 could fall out of compliance. ITAAC #2 can also have a risk curve 622. If ITAAC #1 and ITAAC #2 are related in some respect, they both might have relatively high risk at the same time as indicated by their coinciding peaks at the right of graph 600.

The maximum peaks of curves 612 and 622 represent dates were each ITAAC is considered to have a highest risk of compromise. These dates can be consider the most likely compromise dates referenced early. Given these dates, estimation engine can provide a recommendation, possibly through an ICV form or ICRC, that another inspection be scheduled for those dates to reduce risk or ensure components retain closure.

If an estimation engine determines a risk is too high or estimation date lacks certainty according to one or more rules of an ITAAC, the engine can consult historical workflow data points or other information available in the workflow database to determine if alternative approaches are available to avoid acceptance the ITAAC object from becoming compromised. For example, to extend the welding inspection example further, an assigned welder or inspector might have less experience with a specific type of component, which can cause compliance dates associated with the components to have undesirable characteristics. The risk of an inexperienced welder could cause a date to be pushed back, could increase risk to other components, or could cause other negative effects. However, the estimation engine can search for other welders or inspectors that would shore up the certainty. These new assignment recommendations can be presented within a report to partners, clients, agencies, or other users of the system.

One should note that a recommendation might include an unexpected combination of resources that the system identifies as being correlated, possibly through running simulations. For example, a welder that is inexperienced in combination with an inspector might be recommended because the two individuals work well with each other. Although the example has been illustrated using individuals, it should be appreciated that many different factors could be recommended alone or in combination with others including time of work, materials, suppliers, schedules, individuals, or other items.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C and N, the text should be interpreted as requiring only one element from the group, not A plus N, or B plus N, etc.

What is claimed is:

1. A construction workflow tracking system, the system comprising:
a workflow engine including a workflow database storing on a tangible medium (a) project closure acceptance criteria objects relating to a construction project, (b) workflow data points associated with each of the closure acceptance criteria objects, and (c) compliance requirements associated with each criteria object indicating compliance with closure acceptance criteria;
a partner interface through which partners participating in the construction project submit the workflow data points to the workflow engine;
an estimation engine coupled with the workflow engine and configured to generate estimated compliance dates of at least some of the project closure acceptance criteria objects as a function of the workflow data points and the compliance requirements associated with the closure acceptance criteria objects; and
a reporting engine coupled with the estimation engine and configured to compile and present a closure report indicating the estimated compliance dates.

2. The system of claim 1, wherein the estimated compliance dates include an estimated inspection date of a component associated with one of the project closure acceptance criteria objects.

3. The system of claim 1, wherein the estimated compliance dates include an estimated acceptance date associated with one of the project closure acceptance criteria objects.

4. The system of claim 1, wherein the workflow data points comprise component-level attributes.

5. The system of claim 4, wherein the estimation engine is further configured to correlate the workflow data points with the acceptance criteria objects by matching workflow attributes with acceptance criteria object attributes.

6. The system of claim 5, wherein the workflow attributes and acceptance criteria object attributes are both stored according to a normalized common attribute schema the estimation engine is further configured to correlate the workflow data points with the acceptance criteria objects by establishing relationships among workflow attributes and the acceptance criteria object attributes according to the schema.

7. The system of claim 1, wherein the acceptance criteria objects correspond to standardized acceptance criteria.

8. The system of claim 7, wherein the acceptance criteria objects correspond to Inspection, Tests, Analyses, and Acceptance Criteria (ITAAC).

9. The system of claim 8, wherein the ITAAC-based acceptance criteria objects are associated with an Advanced Boiling Water Reactor (ABWR).

10. The system of claim 1, wherein the reporting engine is further configured to provide a real-time audit trail for at least one of the construction project's closure acceptance criteria object.

11. The system of claim 1, wherein the workflow database is further configured to archive the workflow data points for at least four years.

12. The system of claim 1, wherein the estimation engine is further configured to generate a confidence level for the estimated compliance date.

13. The system of claim 12, wherein the confidence level is a function of historical acceptance criteria objects from previous construction projects.

14. The system of claim 12, wherein the confidence level is a function of updates to the workflow data points.

15. The system of claim 12, wherein the confidence level is calculated as a function of simulation the construction project based on previous construction project workflow data points.

16. The system of claim 1, wherein the estimation engine is further configured to generate an estimated risk of at least one of the acceptance criteria objects becoming compromised.

17. The system of claim 16, wherein the at least one of the acceptance criteria objects is considered to be in compliance with its corresponding compliance requirements.

18. The system of claim 17, wherein the reporting engine is further configured to generate a risk mitigation recommendation to avoid the at least one of the acceptance criteria objects from becoming compromised.
